(19) United States
(12) Patent Application Publication
(10) Pub. No.: US 2010/0150561 A1
(43) Pub. Date: Jun. 17, 2010

(54) OPTICAL RECEIVER, OPTICAL LINE TERMINAL AND METHOD OF RECOVERING RECEIVED SIGNALS

(76) Inventors: Seung-hyun CHO, Daejeon-si (KR); Byoung-shi KIM, Daejeon-si (KR); Man-yong PARK, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/625,299

(22) Filed: Nov. 24, 2009

(30) Foreign Application Priority Data
Dec. 12, 2008 (KR) 10-2008-0126809
Mar. 16, 2009 (KR) 10-2009-0022161

(51) Int. Cl. H04B 10/06; H04J 14/02

(52) U.S. Cl. 398/79; 398/208

(57) ABSTRACT

An optical receiver is provided which can be applied to a wavelength division multiplexing passive optical network (WDM PON) based on a reflective semiconductor optical amplifier employing a wavelength reuse scheme. The optical receiver includes a photo diode to convert an optical signal to an electrical signal; a pre-amplifier to linearly amplify the electrical signal and convert the amplified electrical signal to a voltage signal; a post-amplifier, which is equipped with a gain control function, to convert the voltage signal to a signal with a constant output level and to control a decision threshold of the converted signal; and an offset voltage generator to generate a predetermined offset voltage for the decision threshold control of the post-amplifier and to provide the offset voltage to the post-amplifier. Accordingly, it is possible to increase an extinction ratio of a downstream optical signal to a predetermined level in the WDM PON based on a reflective semiconductor optical amplifier employing a wavelength reuse scheme, and it is possible to reduce an optical power, which is received by the reflective semiconductor optical amplifier incorporated in a subscriber terminal, below a predetermined level. As a result, it is possible to improve transmission quality of the downstream and upstream optical signals.

### CROSS-REFERENCE TO RELATED APPLICATIONS

This application claims the benefit under 35 U.S.C. §119(a) of Korean Patent Application Nos. 10-2008-0126809, filed on Dec. 12, 2008, and 10-2009-0022161, filed on Mar. 16, 2009, the disclosures of which are incorporated by reference in its entirety for all purposes.

### BACKGROUND

1. Field

The following description relates to an optical receiver and, more particularly, to an optical receiver in a wavelength division multiplexing passive optical network (WDM PON) based on a reflective semiconductor optical amplifier employing a wavelength reuse scheme.

2. Description of the Related Art

In a wavelength division multiplexing passive optical network (WDM PON) which employs a reflective semiconductor optical amplifier (RSOA) as an optical source of a central base station or of a subscriber terminal, RSOA is not wavelength-dependent. This has recently gained increased interest in that it helps solve handling of stored optical transceiver modules on a system level.

For a passive optical network employing the reflective semiconductor optical amplifier as an optical source, there exist a variety of upstream/downstream optical signal transmission schemes. Among them, an optical signal transmission scheme which reuses a downstream optical signal to transmit an upstream optical signal with the same wavelength has become commercialized due to an economical advantage resulting from simplified system and components.

In addition, a passive optical network related technology has been proposed which employs a reflective semiconductor optical amplifier for compensating an optical loss on an optical link to improve an economical efficiency and an efficient use of bandwidth. This is a technology of reusing a downstream optical signal, which is advantageous in terms of a simple and economical technology. However, this approach is disadvantageous in that an extinction ratio of a downstream optical signal needs to be maintained below a predetermined level and, when the downstream optical signal is re-modulated to be transmitted as an upstream optical signal, a residual part of the downstream optical signal included in the upstream optical signal may cause a predetermined level of transmission penalty.

Furthermore, to maintain a transmission quality of an upstream optical signal above a predetermined level and receive a downstream optical signal with a low extinction ratio using a gain saturation characteristic of the semiconductor optical amplifier, the downstream optical signal which is input to a subscriber terminal equipped with the reflective semiconductor optical amplifier needs to have more than a predetermined power level.

Furthermore, this approach is disadvantageous in that an optical power penalty due to a bit intensity noise created when a signal is transmitted in both ways on a signal optical fiber is induced on transmission of both of the upstream and downstream optical signals. In addition, this approach is disadvantageous in that an optical power penalty due to an increased relative optical intensity noise created when a broadband optical source based on a spectrum-sliced seed light and erbium-added optical amplifier is used is induced.

To address these problems, there has been proposed a method which has improved an optical power penalty by injecting a dynamic current to an optical transmitter based on a semiconductor optical amplifier in a subscriber terminal. This approach relates to a semiconductor optical amplifier appropriate for wavelength reuse and an electrical driver for effectively reusing a downstream optical signal as an upstream optical signal by injecting an appropriate dynamic current to the semiconductor optical amplifier depending on a type of the downstream optical signal. This approach is mainly intended to solve a problem on an optical transmitter. Accordingly, while this method is an effective approach to improve the optical power penalty, it is not an ultimate solution to address the above-mentioned problems.

### SUMMARY

The following description relates to an optical receiver which increases an extinction ratio of a downstream optical signal to a predetermined level or more and enables a communication below a predetermined level of optical power of the downstream optical signal injected into a semiconductor optical amplifier in a passive optical network system based on a reflective semiconductor optical amplifier reusing the downstream optical signal.

In addition, the following description relates to an optical receiver which improves an optical power penalty due to an increased relative optical intensity noise created when a broadband optical source based on a spectrum-sliced seed light and erbium-added optical amplifier is used.

Furthermore, the following description relates to an optical receiver which improves an optical power penalty due to an optical intensity noise associated with reflection and Rayleigh backscattering created when a signal is transmitted in both ways on a signal optical fiber.

In one general aspect, an optical receiver includes: a photo diode to convert an optical signal to an electrical signal; a pre-amplifier to linearly amplify the electrical signal and convert the amplified electrical signal to a voltage signal; a post-amplifier, which is equipped with a gain control function, to convert the voltage signal to a signal with a constant output level and to control a decision threshold of the converted signal; and an offset voltage generator to generate a predetermined offset voltage for the decision threshold control of the post-amplifier and to provide the offset voltage to the post-amplifier.

However, other features and aspects will be apparent from the following description, the drawings, and the claims.

### BRIEF DESCRIPTION OF THE DRAWINGS

FIG. 1 is a diagram illustrating a received signal in a conventional optical receiver.

FIG. 2 is a diagram illustrating an exemplary optical receiver.

FIG. 3 is a graph illustrating a variation of an output voltage level to an input optical power in three types of pre-amplifiers.

FIGS. 4 to 6 are diagrams illustrating a change in decision threshold according to a change of an output voltage level to an input output power.

FIGS. 7A to 7C illustrate output eye diagrams for an offset input voltage of an exemplary second post-amplifying part capable of controlling a decision threshold.

FIG. 8 is a diagram illustrating an exemplary offset voltage generator.

FIGS. 9A, 9B, 10A and 10B are graphs illustrating transmission test results in an exemplary optical receiver.

FIGS. 11A, 11B and 12 are graphs illustrating transmission test results in an exemplary optical receiver.

FIG. 13 is a block diagram of an exemplary optical line terminal.

FIG. 14 is a flow chart illustrating an exemplary method of recovering a received signal.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

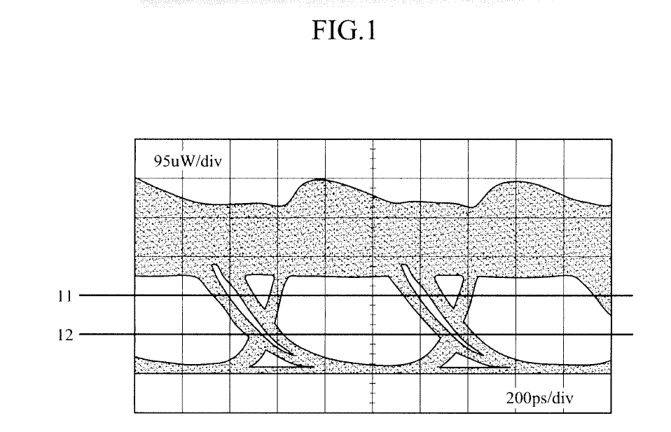

FIG. 1 is a diagram illustrating a received signal in a typical optical receiver. As shown in FIG. 1, noise components caused by conventional problems are mainly located at level “1” of an optical signal. It can be seen from an eye diagram of FIG. 1 that a re-modulated downstream optical signal causes a thickness of level “1” to become thicker than a thickness of level “0”. That is, an extinction ratio of the downstream optical signal appears to be greatly reduced due to a gain compression, which is one of characteristics of a reflective semiconductor optical amplifier, but remains at a predetermined level or more.

For an optical receiver including traditional photo diode, pre-amplifier and post-amplifier, a decision threshold is mostly fixed to an average of level “1” and level “0” (see 11 in FIG. 1). Since this cannot be changed, if a thickness of level “1” is large, this causes an increased bit error rate upon demodulation of a digital signal.

In addition, a slow frequency response, which is one of characteristics of the reflective semiconductor optical amplifier, causes increased rising and falling times of a digital modulation signal. This may be converted to a timing jitter on a system. When conventional optical receiver is used, the timing jitter is known as a major cause of a power penalty generated upon transmitting an optical signal.

An exemplary optical receiver with a variable decision threshold capability may increase an extinction ratio of a downstream optical signal to a predetermined level on a wavelength division multiplexing passive optical network (WDM PON) based on a reflective semiconductor optical amplifier reusing the downstream optical wavelength signal, thereby improving transmission quality of downstream and upstream optical signals.

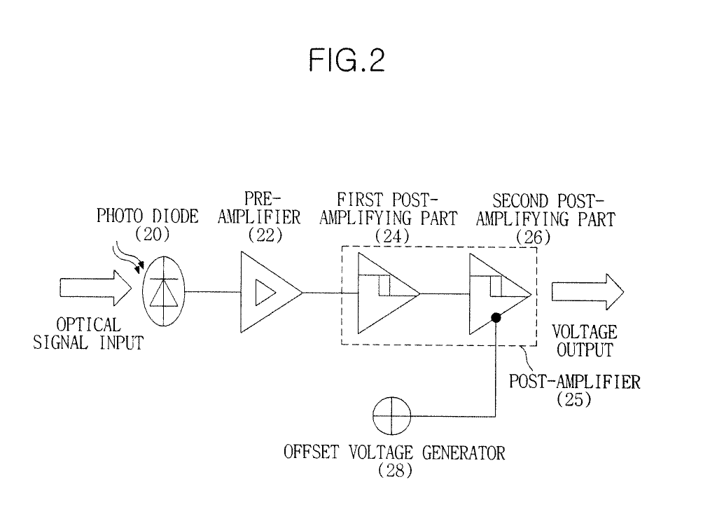

FIG. 2 is a diagram illustrating an exemplary optical receiver.

The optical receiver includes a photo diode 20, a pre-amplifier 22, a post-amplifier 25 and an offset voltage generator 28.

The photo diode 20 may be of a PIN type or an avalanche type. In the current example, the photo diode 20 converts an optical signal to an electrical signal.

The pre-amplifier 22 is a transimpedance amplifier, which converts the electrical signal from the photo diode 20 into a voltage signal and amplifies the voltage signal. In the current example, the pre-amplifier 22 may be adapted to be a continuous-mode pre-amplifier below a predetermined frequency band in case of an application receiving a continuous-mode signal. In addition, in case of an application receiving a burst mode signal, the pre-amplifier 22 may be adapted to be a burst-mode pre-amplifier below a specific frequency band.

More specifically, the post-amplifier 25 includes a first post-amplifying part 24 and a second post-amplifying part 26. The first post-amplifying part 24 is equipped with an automatic gain control function and is configured to maintain an output voltage at a constant level according to an input optical power within a dynamic input range of the optical receiver.

The second post-amplifying part 26 is configured to determine a decision threshold appropriate for a noise distribution pattern of a signal input to the optical receiver. Accordingly, if an appropriate DC offset voltage is input to the second post-amplifying part 26, the second post-amplifying part 26 serves to output a signal with an appropriate cross point on the output eye diagram. The DC offset voltage for controlling the decision threshold is received from the offset voltage generator 28 for controlling the decision threshold. In the current example, the first post-amplifying part 24 and the second post-amplifying part 26 may be integrated into a single entity or physically separated from each other.

The offset voltage generator 28 includes a reliable voltage regulator and a voltage divider to convert the output of the voltage regulator to a value suitable for uses. In the current example, the voltage divider employs a variable resistor as a load resistor.

In case of a wavelength reuse scheme, asymmetric noise components, which are generated in a re-modulation process of an optical signal with the same wavelength, and asymmetric noise components, which are generated when the optical signal with the same wavelength is transmitted in both ways on a single optical fiber, are mostly distributed on level “1” of the optical signal, as can be seen from FIG. 1. The optical signal shown in FIG. 1 is input to the photo diode and converted to an electrical signal.

In a process of converting the optical signal to the electrical signal, the asymmetric noise components of the optical signal are converted to an electrical signal of a current type without any change and distortion in shape and form. The type of the photo diode 20 may be determined by taking into account a power budget of a link to be used and an optical path penalty due to wavelength reuse.

More specifically, for example, for a long transmission distance and a large optical path penalty, an avalanche photo diode with a good reception sensitivity may be used. Since the avalanche photo diode needs a high bias drive voltage, an additional high bias voltage generator is needed. In addition, since the avalanche photo diode is changed in breakdown voltage depending on its operating temperature, a temperature compensator for applying a bias voltage is needed to compensate for the changed breakdown voltage.

For example, for an optical receiver for short-range transmission with a low link power budget, a PIN photo diode may be used since it is not expensive and is configured with a simple circuit arrangement.

The pre-amplifier 22 converts the electrical signal of a current type from the photo diode 20 into an electrical signal of a voltage type to have a reception level characteristic appropriate for a digital communication system. In the current example, the pre-amplifier 22 may be a transimpedance amplifier which is widely used to convert a current signal to a voltage signal. In addition, the pre-amplifier 22 may be equipped with an automatic gain control function. In this case, however, if a low optical power level near a reception sensitivity is input, an output level corresponding to the input level tends to be significantly reduced, or an output voltage tends to be decreased in proportion to a reduced input optical power.

That is, although the pre-amplifier is equipped with the automatic gain control function, it does not always provide a constant output characteristic within a total input dynamic range.

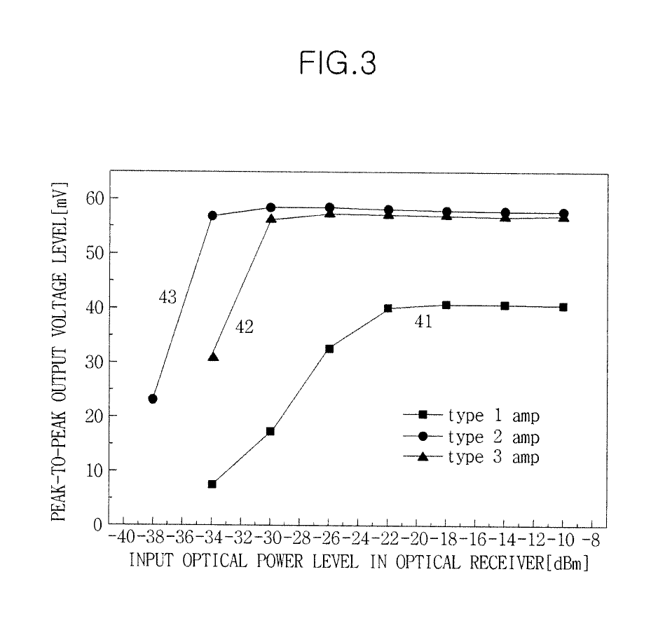

FIG. 3 is a graph illustrating a variation of an output voltage level to an input optical power in three types of pre-amplifiers. Each of the pre-amplifiers uses an avalanche photo diode. It can be seen from FIG. 3 that each of the pre-amplifier is significantly reduced in a peak-to-peak output voltage level when an input optical power is reduced to near the reception sensitivity. Accordingly, a pre-amplifier equipped only with an automatic gain control function is not enough to output a constant voltage signal. The first post-amplifying part 24 equipped with an automatic gain control function may solve this problem.

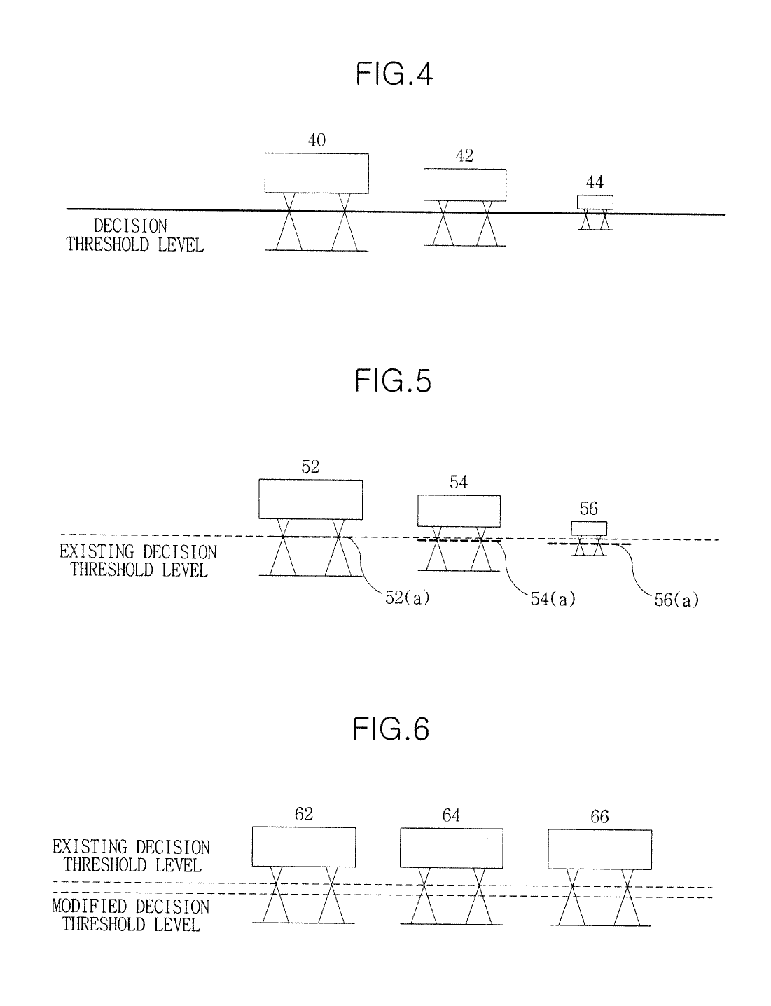

FIGS. 4 to 6 are diagrams illustrating a change in decision threshold according to a change of an output voltage level to an input output power.

More specifically, FIG. 4 illustrates a case where a decision threshold is fixed to a predetermined value as an output voltage level is changed with respect to an input optical power. It can be seen from FIG. 4 that when the input optical power level which is input to the optical receiver is decreased in order of 40→42→44, a noise signal contained in level “1” causes an increased chance of an erroneous signal decision. In this case, as shown in FIG. 5, the decision threshold level needs to be automatically changed according to the change in the input optical power level. That is, if the optical power level is decreased in order of 52→54→56, the decision threshold needs to be decreased in order of 52(a)→54(a)→56(a) to correctly receive the reduced input signal.

On the other hand, regardless of the type of the pre-amplifier, the first post-amplifying part 24 equipped with a buffer-type automatic gain control function may solve the above-mentioned problem. The post-amplifier linearly amplifies the output signal of the pre-amplifier to a predetermined level which can be digitally discriminated. With this function, when the automatically gain-controlled output level is provided to the second post-amplifying part 26, the same output signal level is provided near the reception sensitivity. Accordingly, although a large noise component remains in level “1”, the output is regardless of the input optical power level. Hence, the decision threshold needs not to be changed as shown in FIG. 5. In other words, although a fixed decision threshold is provided, it is possible to maintain a constant reception sensitivity within the total input dynamic range of the optical receiver.

FIG. 6 illustrates a reception sensitivity which is constantly maintained. Referring to FIG. 6, although the input optical power is reduced in order of 62→64→66→, the signal level input to the second post-amplifying part 26 is maintained at a constant value. Hence, the decision threshold needs not to be adjusted according to the input optical power. However, a decision threshold which is a little lower than the existing decision threshold level may result in an improved optical reception performance.

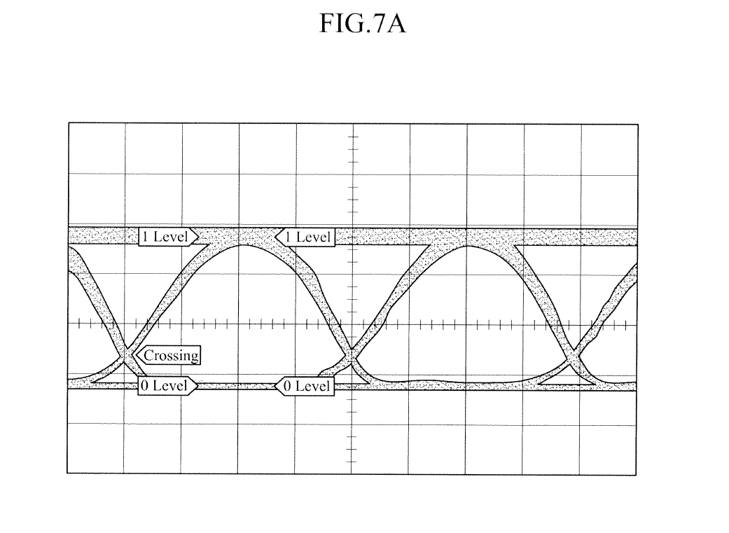

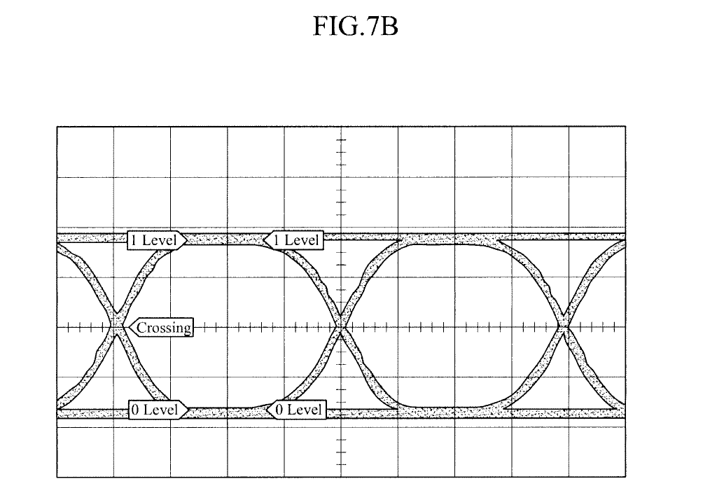

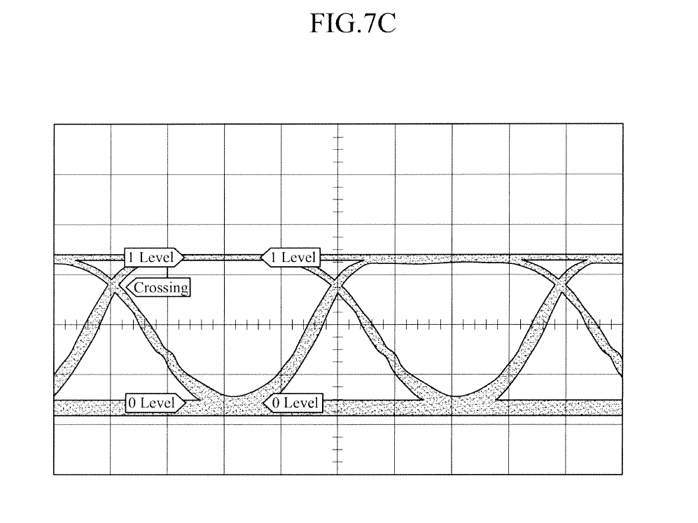

FIGS. 7A to 7C illustrate output eye diagrams for an offset input voltage of an exemplary second post-amplifying part capable of controlling a decision threshold.

In the current example, the second post-amplifying part 26 may be implemented as a limiting amplifier. If a specific voltage level is applied to a DC offset input terminal of the limiting amplifier, a cross point may be changed on an output eye diagram. The change of the cross point may be a result of a direct reflection of a change in the decision threshold. The change in the decision threshold may result in an improved reception characteristic of the optical signal.

FIG. 7A illustrates a cross point on an output eye diagram of the second post-amplifying part 26, which is disposed at a position of about 20% of level “0” in magnitude by applying a certain voltage level to a DC offset input terminal of the second post-amplifying part 26. In this case, a decision threshold in a clock data recovery block becomes a 20% cross point on the eye diagram.

FIG. 7B illustrates a cross point on an output eye diagram of the second post-amplifying part 26, which is disposed at a position of about 50% of level “0” in magnitude by applying another voltage level to the DC offset input terminal of the second post-amplifying part 26. This may be a general characteristic of the optical receiver which is applied to a conventional optical communication system with no a variable decision threshold capability. In this case, the decision threshold becomes a 50% cross point on the eye diagram, as described above.

FIG. 7C illustrates a cross point on an output eye diagram of the second post-amplifying part 26, which is disposed at a position of about 80% of level “0” in magnitude by applying another voltage level to the DC offset input terminal of the second post-amplifying part 26. For this output eye diagram, the decision threshold is reduced to near level “0” when a noise signal contained in level “1” is greater than a noise signal contained in level “0”. In this case, the cross point appears to rise to near level “1” on the output eye diagram.

On the contrary, the decision threshold is increased when a noise signal contained in level “0” is greater than a noise signal contained in level “1”. In this case, the cross point appears to drop to near level “0” on the output eye diagram.

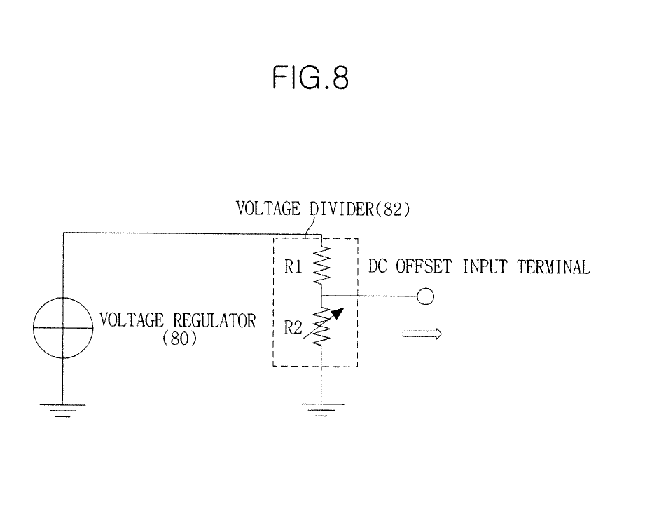

FIG. 8 is a diagram illustrating an exemplary offset voltage generator.

The offset voltage generator 28 includes a voltage regulator 80 and a voltage divider 82. The voltage divider 82 produces an output voltage which is a fraction of a constant voltage from the voltage regulator according to the ratio of R1 and R2. Resistor R2 may be implemented as a variable resistor to control the output voltage.

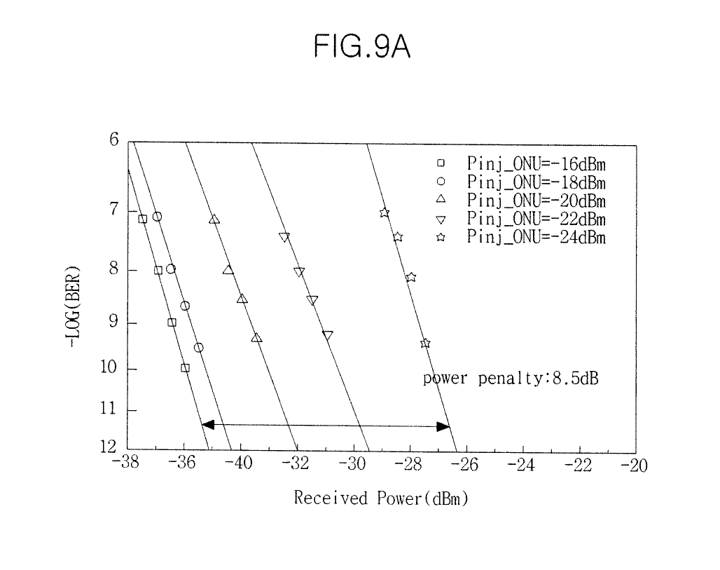

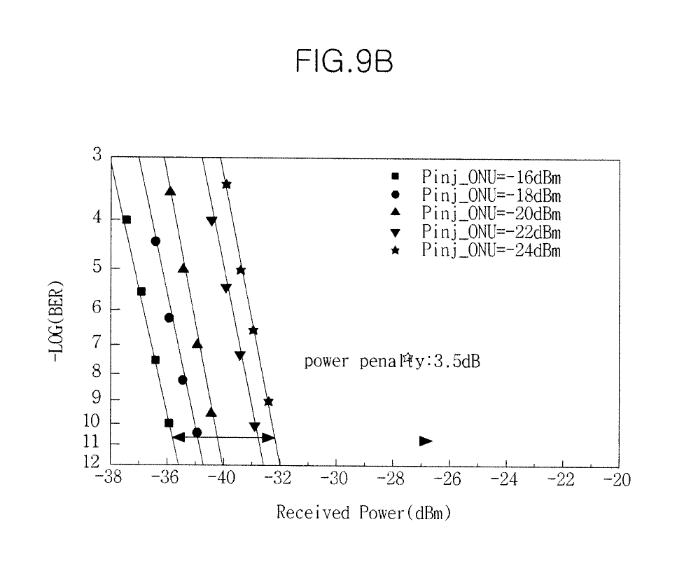

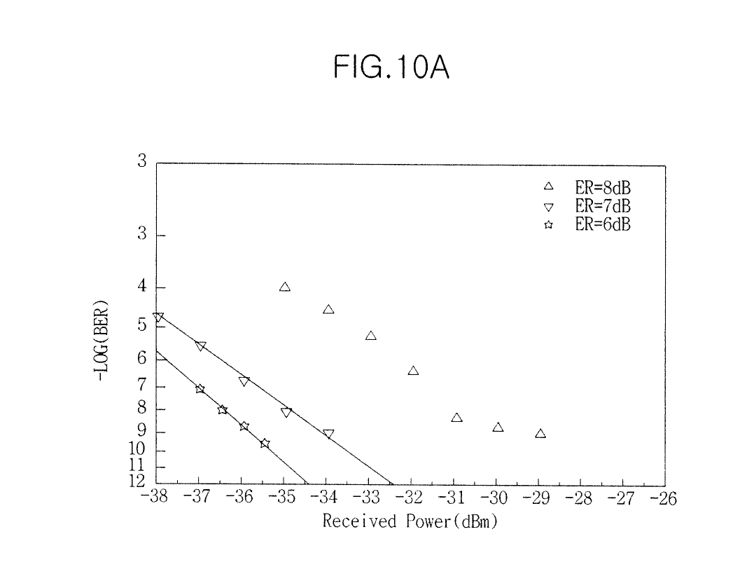

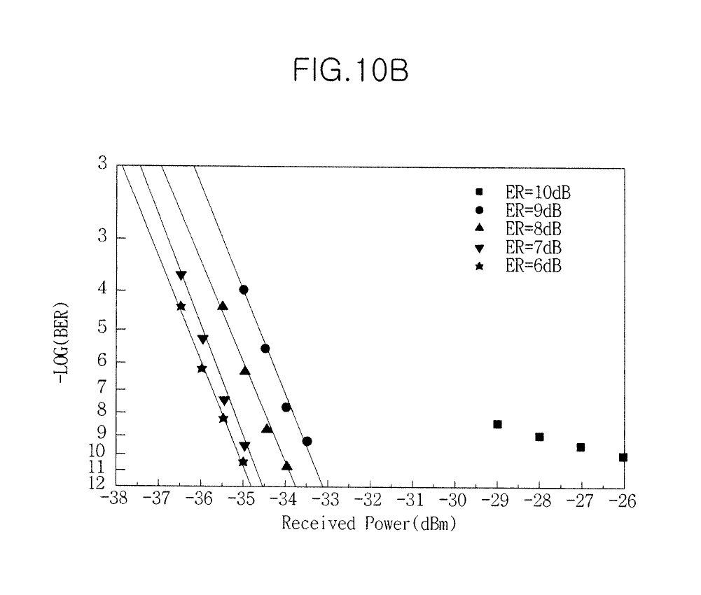

FIGS. 9A, 9B, 10A and 10B are graphs illustrating transmission test results in an exemplary optical receiver.

More specifically, FIGS. 9A and 9B illustrate a characteristic graph of a received signal when an extinction ratio of a downstream optical signal is fixed.

FIG. 9A illustrates a transmission test result of an upstream optical signal, which is measured using a conventional optical receiver with respect to a varying power that is input to an optical transmitter based on a reflective semiconductor optical amplifier incorporated in a subscriber terminal while an extinction ratio of a downstream optical signal is fixed to 6 dB. Referring to FIG. 9A, a reduced input optical power causes an increased remaining extinction ratio component of the downstream optical signal due to an insufficient gain compression, resulting in a poor upstream transmission characteristic.

An input optical power reduced from −16 dBm to −24 dBm results in an optical power penalty of a maximum of 8.5 dB. On the other hand, FIG. 9B illustrates a transmission test result of an upstream optical signal, which is measured using an exemplary optical receiver. Referring to FIG. 9B, the optical power penalty may be reduced to 3.5 dB, resulting in an improvement of about 5 dB.

FIGS. 10A and 10B are characteristic graphs of a received signal when the magnitude of an optical power received by the optical receiver is fixed.

Referring to FIGS. 10A and 10B, while an optical power received by the optical receiver based on a reflective semiconductor optical amplifier incorporated in a subscriber terminal is fixed to −15 dB, an extinction ratio of a downstream optical signal has changed from 6 dB to 10 dB.

FIG. 10A illustrates a result which is measured using a conventional optical receiver. Referring to FIG. 10A, although an extinction ratio of a downstream optical signal reaches 8 dB, a transmission is not possible due to an error floor. Similarly, an increased extinction ratio of the downstream optical signal causes an increased remaining extinction ratio component of the downstream optical signal due to an insufficient gain compression, resulting in a poor upstream transmission characteristic. On the other hand, FIG. 10B illustrates a measurement result of an exemplary optical receiver. Referring to FIG. 10B, although a maximum downstream extinction ratio reaches 9 dB, a good transmission characteristic is maintained with a power penalty of about 2 dB.

Accordingly, it can be seen from FIGS. 9A, 9B, 10A and 10B that the upstream optical signal can be transmitted with the exemplary optical receiver although an extinction ratio of the downstream optical signal is increased above a predetermined level. Furthermore, when a re-modulated downstream optical signal is reused as an upstream optical signal, it is possible to significantly reduce a transmission penalty of a predetermined level or more. In addition, although the magnitude of a downstream optical signal which is input to a subscriber terminal drops below a predetermined level, the upstream optical signal can be transmitted.

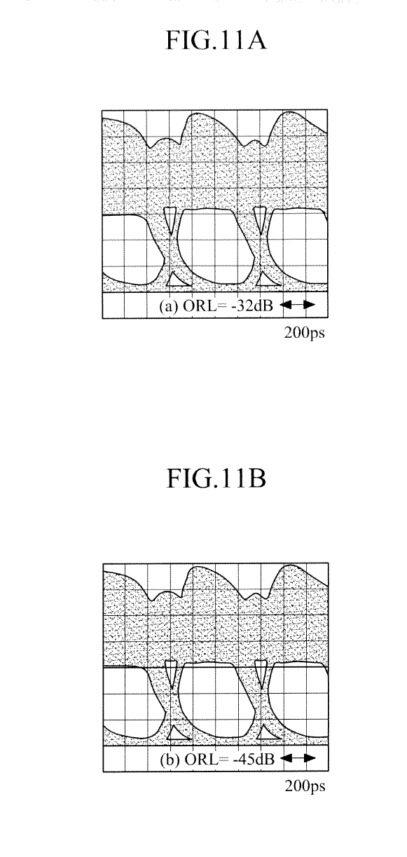

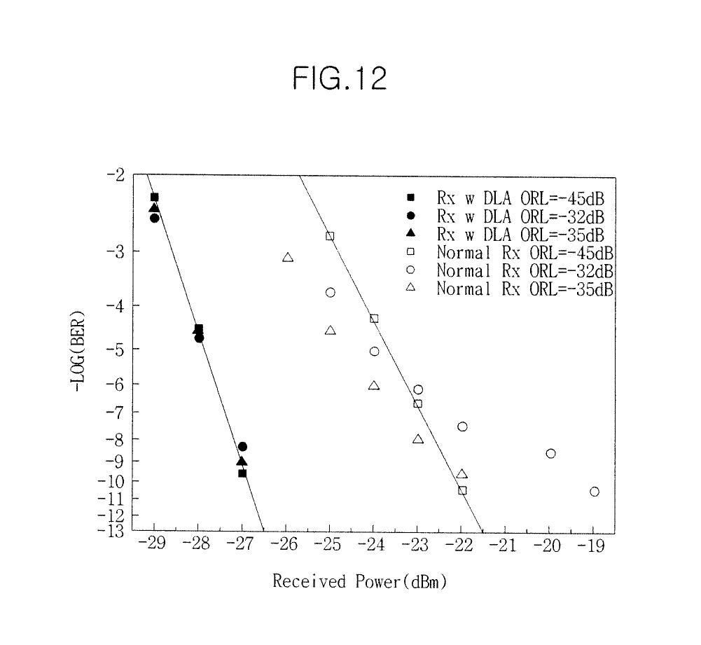

FIGS. 11A, 11B and 12 are graphs illustrating transmission test results in an exemplary optical receiver.

More specifically, FIGS. 11A, 11B and 12 illustrate transmission test results with an improved optical power penalty, where the optical power penalty is generated due to reflection and Rayleigh backscattering when a signal is transmitted in both ways. In other words, when an exemplary optical receiver is used in an upstream optical signal receiver on a passive optical network based on a reflective semiconductor optical amplifier reusing a downstream optical signal, FIGS. 11A, 11B and 12 illustrate transmission test results with an improved optical power penalty, where the optical power penalty is caused by a bit intensity noise generated by the reflection and Rayleigh backscattering when a signal is transmitted in both ways on a single optical fiber.

Referring to FIGS. 11A and 11B, the thickness of level “1” on the optical signal eye pattern has greatly increased due to back reflection. This results from a bit intensity noise, as described above.

FIG. 12 shows that a transmission penalty due to a back reflection noise has improved with an exemplary optical receiver. When there exists back reflection, the exemplary optical receiver exhibits a good reception sensitivity characteristic regardless of the amount of reflection. However, in case of the conventional optical receiver, a great amount of error floor is produced when there exists back reflection. Furthermore, in this case, although there is no reflection, it has an optical power penalty of about 5 dB, comparing to the exemplary optical receiver.

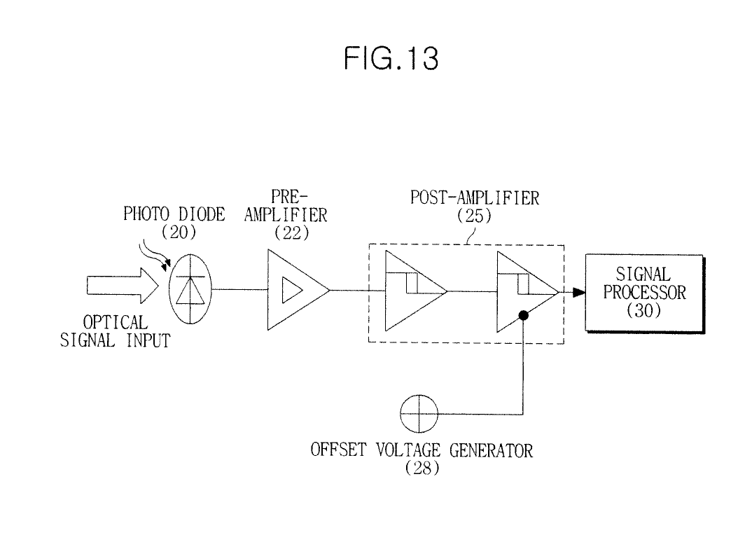

FIG. 13 is a block diagram of an exemplary optical line terminal.

The optical line terminal includes the optical receiver and a signal processor 30.

The signal processor 30 receives an output signal with a controlled decision threshold form the optical receiver, analyzes and processes the output signal. For example, the signal processor 30 may forward a recovered signal to another optical line terminal, or produces a downstream link to send it to an optical network terminal. According to the present invention, it is possible to make a more accurate recovery of a received signal and ensure a more reliable signal processing on an optical communication network.

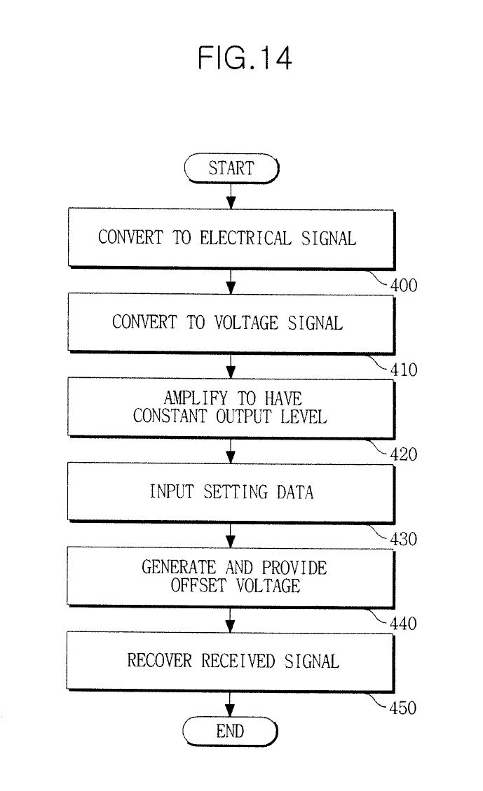

FIG. 14 is a flow chart illustrating an exemplary method of recovering a received signal.

The photo diode converts a received optical signal to an electrical signal (operation 400). The electrical signal of a current type is linearly amplified and converted to a voltage signal (operation 410). The converted voltage signal is amplified to a signal with a predetermined output level (operation 420).

Based on predetermined data, a decision threshold of the amplified output signal is controlled. The predetermined data for controlling the decision threshold may be setting data which is input from a user (operation 430). According to the setting data, an offset voltage for controlling the decision threshold is created and provided (operation 440). In the current example, the offset voltage may, without limitation, be provided by using a variable resistor included in a voltage divider which divides a constant voltage from a voltage regulator.

The received signal with a controlled decision threshold is recovered (operation 450). Accordingly, it is possible to make a more accurate recovery of a received signal.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

As apparent from the above description, the optical receiver with a variable decision threshold capability can increase an extinction ratio of a downstream optical signal to a predetermined level in a wavelength division multiplexing passive optical network based on a reflective semiconductor optical amplifier reusing the downstream optical signal, thereby improving a transmission quality of the downstream optical signal.

Furthermore, an operating range of an input optical power of a reflective semiconductor optical amplifier can be reduced below a gain saturation input optical power level, thereby improving a link power budget.

In addition, it is possible to improve upstream/downstream transmission penalty due to a back reflection-related optical intensity noise created when a signal is transmitted in both ways on a single optical fiber, and to improve a transmission quality of an upstream signal due to an increased extinction ratio of a downstream signal. Further, it is possible to improve transmission quality of upstream and downstream signals due to an increased relative optical intensity noise created when a broadband optical source based on a spectrum-sliced seed light and erbium-added optical amplifier is used.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical receiver comprising:
a photo diode to convert an optical signal to an electrical signal;
a pre-amplifier to linearly amplify the electrical signal and convert the amplified electrical signal to a voltage signal;
a post-amplifier, which is equipped with a gain control function, to convert the voltage signal to a signal with a constant output level and to control a decision threshold of the converted signal; and
an offset voltage generator to generate a predetermined offset voltage for the decision threshold control of the post-amplifier and to provide the offset voltage to the post-amplifier.

2. The optical receiver of claim 1, wherein the post-amplifier comprises:
a first post-amplifying part, which is equipped with a gain control function, to convert the voltage signal to a signal with a constant output level; and
a second post-amplifying part to control a decision threshold of the signal with the constant output level which is output from the first post-amplifying part.

3. The optical receiver of claim 1, wherein the pre-amplifier is a continuous-mode pre-amplifier.

4. The optical receiver of claim 1, wherein the pre-amplifier is a burst-mode pre-amplifier.

5. The optical receiver of claim 1, wherein the offset voltage generator comprises:
a voltage regulator to output a constant voltage; and
a voltage divider to produce an output voltage which is a fraction of the constant voltage from the voltage regulator.

6. The optical receiver of claim 5, wherein the voltage divider comprises a variable resistor configured to vary a resistance.

7. An optical line terminal in a wavelength division multiplexing passive optical network (WDM PON) based on a reflective semiconductor optical amplifier employing a wavelength reuse scheme, comprising:
a photo diode to convert an optical signal, which is received from a plurality of optical network terminals or optical network units, to an electrical signal of a current type;
a pre-amplifier to linearly amplify the electrical signal and convert the amplified electrical signal to a voltage signal;
a post-amplifier, which is equipped with a gain control function, to convert the voltage signal to a signal with a constant output level and control a decision threshold of the converted signal;
a signal processor to analyze and process the converted signal output from the post-amplifier, and
an offset voltage generator to generate a predetermined offset voltage for the decision threshold control of the post-amplifier and to provide the offset voltage to the post-amplifier.

8. The optical line terminal of claim 7, wherein the post-amplifier comprises:
a first post-amplifying part, which is equipped with a gain control function, to convert the voltage signal to a signal with a constant output level; and
a second post-amplifying part to control a decision threshold of the signal with the constant output level which is output from the first post-amplifying part.

9. The optical line terminal of claim 1, wherein the offset voltage generator comprises:
a voltage regulator to output a constant voltage; and
a voltage divider to produce an output voltage which is a fraction of the constant voltage from the voltage regulator.

10. The optical line terminal of claim 9, wherein the voltage divider comprises a variable resistor configured to vary a resistance.

11. A method of recovering a received signal in a wavelength division multiplexing passive optical network (WDM PON) based on a reflective semiconductor optical amplifier employing a wavelength reuse scheme, comprising:
converting a received optical signal to an electrical signal;
linearly amplifying the electrical signal and converting the amplified electrical signal to a voltage signal;
amplifying the voltage signal to a signal with a constant output level;
controlling a decision threshold of the amplified output signal based on predetermined data.

12. The method of claim 11, wherein controlling the decision threshold comprises:
receiving predetermined data for the decision threshold control; and
generating and providing an offset voltage for the decision threshold control according to the predetermined data.
